(19) United States
(12) Patent Application Publication
(10) Pub. No.: US 2002/0011362 A1
(43) Pub. Date: Jan. 31, 2002

(54) Braking control device for an electrically-powered vehicle

(76) Inventor: Hiroshi Toda, Kariya-shi (JP)

Correspondence Address: Platon N. Mandros, Esquire, BURNS, DOANE, SWECKER & MATHIS, L.L.P., P.O. Box 1404, Alexandria, VA, 22313-1404, US

(21) Appl. No.: 09/884,952

(22) Filed: Jun. 21, 2001

(30) Foreign Application Priority Data
Jun. 21, 2000 (JP) 2000-186700

(51) Int. Cl. B60K 1/00; B60K 6/00

(52) U.S. Cl. 180/65.2; 303/3

(57) ABSTRACT

An electric vehicle braking control device includes a battery, an electric motor driving at least one wheel with electric energy of the battery, an electric energy re-generating mechanism that restores electric energy generated to the battery, a static pressure generator generating fluid pressure according to a brake pedal depressing force, a dynamic pressure generator generating a fluid pressure substantially equal to that generated by the static pressure generating mechanism, a first braking mechanism connected to the static pressure generating mechanism, a second braking mechanism connected to the dynamic pressure generating mechanism, a valve disposed in a fluid conduit connecting the dynamic pressure generating mechanism to the second braking mechanism to generate designated differential pressure with no steps, and a control that controls the valve to generate a differential pressure corresponding to the fluid pressure equivalent to the re-generating braking force applied by the electric energy re-generating mechanism.

This application is based on and claims priority under 35 U.S.C. § 119 with respect to Japanese Application No. 2000-186700 filed on Jun. 21, 2000, the entire content of which is incorporated herein by reference.

### FIELD OF THE INVENTION

The present invention generally relates to a braking control device. More particularly, the present invention pertains to a braking control device for an electrically-powered vehicle which connects a static pressure generating device to one of a front wheel side and a rear wheel side, and connects a dynamic pressure generating device to the other of the front wheel side and the rear wheel side.

### BACKGROUND OF THE INVENTION

Generally speaking, an electrically-powered vehicle operates by virtue of the electric energy stored in a battery. The capacity or amount of electric energy which can be stored in the battery is limited. It is thus necessary to utilize the energy of the vehicle in order for the vehicle to run longer with a one-time battery charge. Therefore, in electrically-powered vehicles, it is very effective to utilize regenerative braking in the vehicle. In other words, the potential waste of energy of the vehicle can be reduced during the braking condition when an electric motor connected to a wheel of the vehicle is driven by the kinetic energy of the vehicle and the electric energy which is generated by the electric motor is restored to the battery.

However, because the capacity of the regenerative braking force is limited, a fluid pressure braking force is used with the regenerative braking force at the same time in order to compensate for the lack of regenerative braking force (i.e., cooperative control between the re-generating braking force and the fluid pressure braking force).

Under the cooperative control, the regenerative braking force is applied to the vehicle. In known devices, when the fluid pressure braking force is applied in proportion to the depressing force of the brake pedal, an extra braking force corresponding to the regenerative braking force is applied to the vehicle and so the brake feeling deteriorates. Therefore, it is necessary to reduce the fluid pressure braking force by the braking force corresponding to the regenerative braking force.

An example of a known braking control device for an electrically-powered vehicle which aims to reduce the fluid pressure braking force by the braking force corresponding to the regenerative braking force is disclosed in U.S. Pat. No. 5,568,962 issued on Oct. 29, 1996. According to this braking control device, under the cooperative control, a cut valve prevents communication between a master cylinder and the wheel cylinders of the front wheels and rear wheels so that the fluid pressure which is reduced by the fluid pressure equivalent to the regenerative braking force can be applied to the wheel cylinders of the front wheels and rear wheels in cooperation with a dynamic pressure generating device, plural electromagnetic valves and a differential pressure generating valve.

However, in the above braking control device for an electrically-powered vehicle, to reduce the fluid pressure braking force by the braking force corresponding to the regenerative braking force, several additional elements are required, including the cut valve, the plural electromagnetic valves and the differential pressure generating valve. Also, this device requires a complicated fluid pressure circuit. Moreover, switching the cut valve during switching between the cooperative control mode and the uncooperative control mode deteriorates the brake feeling. The reference here to the uncooperative control mode refers to the state when only the fluid pressure braking force is effective.

In recent years, as a substitute for the above-mentioned device which generates the braking force by the mechanical connection between the brake pedal and each of the wheel cylinders, several kinds of brake systems (referred to here as brake-by-wire systems) have been proposed which generate the braking force by an electric signal. By way of example, Japanese Patent Publication No. 2000-25591 published on Jan. 25, 2000 discloses such a system. This brake system calculates a target braking force based on the amount of operation of the brake pedal and applies the target braking force to each of the wheels by an electric signal. This brake system can also apply to each wheel a braking force amount which is irrelevant to or independent of the amount of the operation of the brake pedal. Therefore, this brake system can reduce the braking force applied to each of the wheels by the braking force corresponding to the regenerative braking force by controlling the electric signal without the addition of complicated elements.

However, a mechanical back-up mechanism or an electric redundancy of the control are required in this brake-by-wire system in order to achieve a fail-safe mechanism against various of malfunctions including electric malfunctions.

Therefore, this brake-by-wire system with the regenerative braking leads to an increase in cost as compared with the device which generates the braking force by mechanical connection.

A need thus exists for an electric vehicle braking control device which is not as susceptible to deteriorating the brake feeling during switching between the cooperative control mode and the uncooperative control mode, but which nevertheless is relatively highly reliable and not excessively costly.

### SUMMARY OF THE INVENTION

The braking control device for an electrically-powered vehicle in accordance with one aspect of the invention includes a battery for storing electric energy, an electric motor for driving at least one of a first wheel and a second wheel with electric energy of the battery, an electric energy re-generating device for restoring the electric energy generated by the electric motor to the battery according to rotation of the first wheel and/or the second wheel driven by the electric motor, a static pressure generating device for generating a fluid pressure according to a depressing force of a brake pedal, a dynamic pressure generating device for generating a fluid pressure substantially equal to the fluid pressure generated by the static pressure generating device, a first fluid pressure braking device connected to the static pressure generating device and applying a braking force to the first wheel according to the fluid pressure applied to the first fluid pressure braking device, and a second fluid pressure braking device connected to the dynamic pressure generating device and applying a braking force to the second wheel according to the fluid pressure applied to the second fluid pressure braking device. A valve is disposed in a fluid conduit connecting the dynamic pressure generating device to the second fluid pressure braking device and the valve, and generates designated differential pressure with no steps, and a controller controls the valve on the basis of signals from one or more sensors so that the valve generates the differential pressure corresponding to the fluid pressure equivalent to a re-generating braking force applied by the electric energy re-generating device.

Under the cooperative control, the controller controls the valve to generate the differential pressure corresponding to the fluid pressure equivalent to the re-generative braking force applied by the electric energy re-generating device. The fluid pressure applied to the second fluid pressure braking device becomes the fluid pressure which is reduced by the fluid pressure equivalent to the re-generative braking force as compared with the fluid pressure generated by the dynamic pressure generating device. Therefore, the cooperative control can be executed only by adding the electric energy re-generating device and at least one valve to the fluid pressure braking system.

In addition, the valve is disposed only in the dynamic pressure circuit side and is not disposed in the static pressure circuit side. Therefore, even when the controller, the valve and/or other elements fail, the fluid pressure generated by the static pressure generating device according to the depressing force of the brake pedal is ensured as the braking force to achieve a fail-safe mechanism.

Because the static pressure circuit side is independent of the dynamic pressure circuit side, the influence of controlling the valve which is disposed in the dynamic pressure circuit side is not transmitted to the static pressure circuit side which generates the fluid pressure according to the depressing force of the brake pedal. Therefore, the brake feeling does not significantly deteriorate during switching between the cooperative control mode and the uncooperative control mode.

Preferably, a fluid pressure adjusting device controlled by the controller is disposed at a halfway point of a fluid conduit connecting the valve to the second fluid pressure braking device. The fluid pressure adjusting device is preferably comprised of plural electromagnetic valves and adjusts the fluid pressure applied to the second fluid pressure braking device. Generally speaking, the re-generating braking force fluctuates in the case of changes in the vehicle speed, the amount of electric energy stored in the battery and other factors. Therefore, when the re-generating braking force increases, the fluid pressure applied to the second fluid pressure braking device needs to be reduced by the fluid pressure equivalent to the increase amount of the re-generating braking force. With the present invention, the fluid pressure applied to the second fluid pressure braking device can be reduced with the fluid pressure adjusting device which is controlled by the controller. Moreover, when the fluid pressure applied to the second (or first) fluid pressure braking device is adjusted with this fluid pressure adjusting device, the well-known anti-lock brake control can be executed with the cooperative control at the same time.

A fluid pressure adjusting device controlled by the controller is preferably disposed in a fluid conduit connecting the dynamic pressure generating device to the second fluid pressure braking device. The fluid pressure adjusting device includes plural electromagnetic valves, one of which is the valve and adjusts the fluid pressure applied to the second fluid pressure braking device. In this way, the known anti-lock brake control can be executed with the cooperative control at the same time by a more simple construction.

According to another aspect of the invention, an electric vehicle braking control device includes a battery that stores electric energy, an electric motor that drives at least one of a first wheel and a second wheel with the electric energy of the battery, with electric energy generated by the electric motor being restored to the battery based on rotation of the at least one of the first and second wheels driven by the electric motor, a master cylinder that generates fluid pressure according to a depressing force of a brake pedal, a pump connected to a reservoir to draw fluid from the reservoir and supply fluid pressure, a regulator connected to the pump to receive the fluid pressure from the pump and regulate the fluid pressure to be substantially equal to the fluid pressure generated by the master cylinder, a first wheel cylinder connected to the master cylinder to apply a braking force to the first wheel, and a second wheel cylinder connected to the regulator to apply a braking force to the second wheel. A linear valve is disposed in a fluid conduit connecting the regulator to the second wheel cylinder for generating a designated differential pressure, and a controller is connected to the linear valve to control the linear valve to generate the differential pressure corresponding to a fluid pressure equivalent to a re-generating braking force applied by the motor.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements and wherein:

FIG. 1 is a schematic illustration of the braking control device for an electrically-powered vehicle according to a first embodiment of the present invention; and

FIG. 2 is a schematic illustration of the braking control device for an electrically-powered vehicle according to a second embodiment of the present invention.

### DETAILED DESCRIPTION OF THE INVENTION

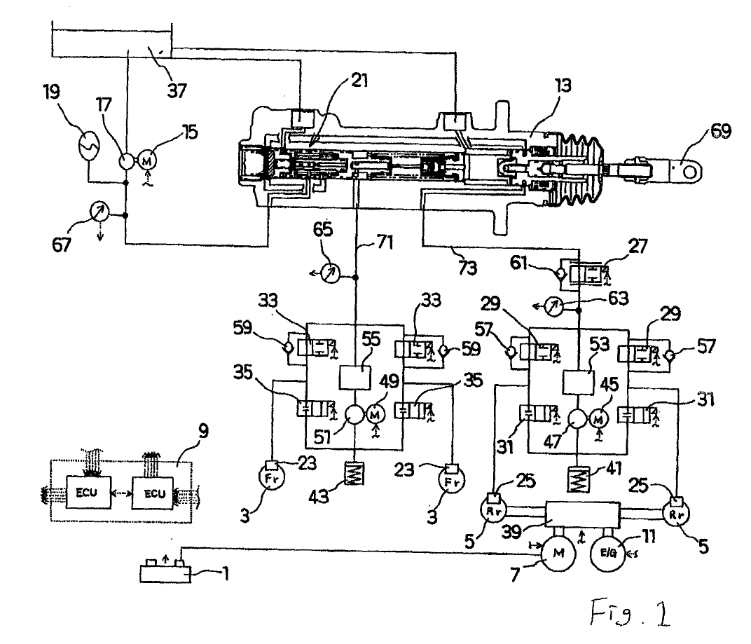

FIG. 1 illustrates the braking control device for an electrically-powered vehicle according to one embodiment of the present invention. In this case, an electrically-powered vehicle is utilized which is driven by a motor driving force in cooperation with an engine driving force (e.g., a rear wheel drive four wheel vehicle).

Referring to FIG. 1, an engine 11 drives the right and left rear wheels 5 (second wheels) by way of a differential gear unit 39. A motor 7 also drives the right and left rear wheels 5 by way of the differential gear unit 39. An allotment between the motor driving force and the engine driving force is calculated and decided by a controller 9 (control means) based on, for example, the operative condition of the vehicle, and the signals of several sensors.

A battery 1 is connected to the motor 7 so that the motor 7 is driven by the electric energy of the battery 1. Under the braking condition, the motor 7 is driven by the revolution of the rear wheels 5 and the electric energy which is generated by the motor 7 can be re-generated at the same time and restored to (stored in) the battery 1. The amount of regenerative or re-generated electric energy is calculated and decided by the controller 9 based on, for example, the battery voltage detected by a voltmeter, the vehicle speed detected by a wheel speed sensor and the condition of the engine 11. The regenerative braking force is applied to the right and left rear wheels 5 in proportion to the amount of regenerative electric energy. An electric energy re-generating means is defined by various features including the controller 9, the battery 1, the motor 7, and the rear wheels 5. The battery voltage is always observed by the controller 9 so that the controller 9 continually observes the voltage of the battery.

A master cylinder 13 forming a static pressure generating means generates fluid pressure into a main conduit 71 of a static pressure circuit side with fluid which is supplied from a reservoir 37 according to operation of a link shaft 69 which reacts in response to a depressing force applied to a brake pedal. The specific details and operation of the master cylinder 13 are well-known to persons in the art and so a detailed description is not included here.

A dynamic pressure generating means is defined by a regulator 21, a motor 15, a pump 17, an accumulator 19, a pressure gauge 67 and the controller 9. The motor 15 drives the pump 17 based on input (signals) from the controller 9. The pump 17 sucks or draws fluid from the reservoir 37 and supplies fluid pressure to the regulator 21. The fluid pressure is stored in the accumulator 19 and is always monitored by the pressure gauge 67. The controller 9 drives the motor 15 intermittently in order to keep the fluid pressure at a predetermined high pressure. The regulator 21 reduces the fluid pressure to a fluid pressure which is substantially equal to the fluid pressure generated in the main conduit 71 of the static pressure circuit side, and supplies this reduced fluid pressure to the main conduit 73 of the dynamic pressure circuit side. The features and operation of the regulator 21 are known to person in the art and so a detailed description of such features and operation is not included here.

The wheel cylinders 23, forming a first fluid pressure braking means, of the right and left front wheels 3 (first wheels) are connected to the master cylinder 13 by way of normally-opened electromagnetic valves 33 and the main conduit 71 of the static pressure circuit side. Normally-closed electromagnetic valves 35 are disposed at a halfway or intermediate point of respective fluid conduits connecting the wheel cylinders 23 and the normally-opened electromagnetic valves 33. A reservoir 43 is connected to both of the normally-closed electromagnetic valves 35. Therefore, in the normal condition (i.e., when none of the valves are operated), the fluid pressure (static pressure) generated by the master cylinder 13 according to the depressing force applied to the brake pedal applies a braking force to the right and left front wheels 3.

The wheel cylinders 25 (second fluid pressure braking means) of the right and left rear wheels 5 are connected to the regulator 21 by way of respective normally-opened electromagnetic valves 29, a linear valve 27 (valve means) and the main conduit 73 of the dynamic pressure circuit side. Normally-closed electromagnetic valves 31 are disposed at a halfway or intermediate point of respective fluid conduits which connect the wheel cylinders 25 and the normally-opened electromagnetic valves 29. A reservoir 41 is connected to the normally-closed electromagnetic valves 31.

The linear valve 27 is normally opened and is adapted to generate a designated differential pressure with no steps by controlling the passing flow rate (or flow amount) through the valve 27. Therefore, in the normal condition (i.e., when none of the valves are operated), the fluid pressure (dynamic pressure) generated by the regulator 21 according to the depressing force of the brake pedal applies a baking force to the right and left rear wheels 5. The electromagnetic valves 33, 35, 29, 31 and the linear valve 27 are controlled by the controller 9.

A fluid pressure adjusting means which is adapted to adjust the fluid pressure applied to the wheel cylinders 25 (i.e., the fluid pressure at the downstream side of the linear valve 27) includes the normally-opened electromagnetic valves 29 and the normally-closed electromagnetic valves 31 which are disposed in the dynamic pressure circuit side. That is, when both the normally-opened electromagnetic valves 29 and the normally-closed electromagnetic valves 31 are not operated (i.e., the valves 29 are open and the valves 31 are closed), the fluid pressure at the downstream side of the linear valve 27 is applied to the wheel cylinders 25 directly. This constitutes the pressure increase mode. In this state, in order to keep or maintain the fluid pressure applied to the wheel cylinders 25 constant, only the normally-opened electromagnetic valves 29 must be operated (i.e., the valves 29 are closed and the valves 31 remain closed). This constitutes the pressure maintain mode. In this state, in order to reduce the fluid pressure applied to the wheel cylinders 25, both the normally-opened electromagnetic valves 29 and the normally-closed electromagnetic valves 31 must be operated (i.e., the valves 29 are closed and the valves 31 are opened). This constitutes the pressure decrease mode.

With this fluid pressure adjusting means, the well-known anti-lock brake control can be executed with respect to the rear wheels 5. Moreover, another fluid pressure adjusting means which can adjust the fluid pressure applied to the wheel cylinders 23 of the front wheels (i.e., the fluid pressure in the main conduit 71 of the static pressure circuit side) includes the normally-opened electromagnetic valves 33 and the normally-closed electromagnetic valves 35 which are disposed in the static pressure circuit side. The known anti-lock brake control described above can also be executed with respect to the front wheels 3.

A pair of check valves 59 which only permit flow in the direction from the wheel cylinders 23 to the main conduit 71 of the static pressure circuit side are disposed parallel to the respective normally-opened electromagnetic valves 33. Also, a pair of check valves 57 which only permit flow in the direction from the wheel cylinders 25 to the main conduit 73 of the dynamic pressure circuit side are disposed parallel to the respective normally-opened electromagnetic valves 29. Further, a check valve 61 which only permits flow in the direction from the wheel cylinders 25 to the main conduit 73 of the dynamic pressure circuit side is disposed parallel to the linear 27. As mentioned above, these check valves 59, 57, 61 only permit flow in the direction from the downstream side to the upstream side. These check valves are not operated in normal use. These check valves are provided to reduce the fluid pressure of the downstream side when the fluid pressure at the downstream side becomes higher than the fluid pressure at the upstream side under an unexpected accident.

A pump 51 is driven by a motor 49 to draw fluid flowing into a reservoir 43 from the normally-closed electromagnetic valves 35 and return the fluid to the master cylinder 13 by way of a damper 55 and the main conduit 71 of the static pressure circuit side. The damper 55 is adapted to reduce discharging pulsation of the pump 51 and to prevent the discharging pulsation of the pump 51 from being transmitted to the master cylinder 13.

A pump 47 is driven by a motor 45 to draw fluid flowing into a reservoir 41 from the normally-closed electromagnetic valves 31 and return the fluid to the regulator 21 by way of a damper 53 and the main conduit 73 of the dynamic pressure circuit side. The damper 53 is adapted to reduce discharging pulsation of the pump 47 and to prevent the discharging pulsation of the pump 47 from being transmitted to the regulator 21. These motor 49, 45 are controlled by the controller 9.

A pressure gauge 67 detects the fluid pressure in the accumulator 19. Another pressure gauge 65 detects the fluid pressure in the main conduit 71 of the static pressure circuit side. A further pressure gauge 63 detects the fluid pressure at the downstream side of the linear valve 27. The outputs of these pressure gauges 67, 65, 63 are sent to the controller 9.

The operation of the braking control device for the electrically-powered vehicle in accordance with the present invention is as follows. Under the normal condition, regenerative brake is always executed to utilize the energy of the vehicle, and the cooperative control as mentioned above with the braking force of the fluid pressure is executed. When the electric energy re-generating means fails, for example when the generator of the motor 7 fails, or when the battery 1 is in the fully-charged condition, regenerative braking is not executed (i.e., the uncooperative control mode). Under the uncooperative control mode, the linear valve 27 is kept open and the fluid pressure generated by the master cylinder 13 and the fluid pressure generated by the regulator 21, both of which are substantially equal to each other, in accordance with the depressing force of the brake pedal are directed to the wheel cylinders 23 and the wheel cylinders 25, respectively, to apply the braking force to the front wheels 3 and the rear wheels 5. At the same time, the known anti-lock brake control can be added and executed as mentioned above.

The operation of the system under the cooperative control is as follows. When the brake pedal is depressed, the controller 9 calculates the amount of the re-generating electric energy which can be stored into the battery 1 as mentioned above, and the electric energy re-generating means stores in the battery 1 the amount of re-generating electric energy which is generated by the motor 7 to apply the re-generating or regenerative braking force to the rear wheels 5. At the same time, the controller 9 calculates the fluid pressure equivalent to the re-generating braking force applied by the electric energy re-generating means.

The controller 9 controls the linear valve 27 so that the fluid pressure at the downstream side of the linear valve 27 detected by the pressure gauge 63 becomes lower than the fluid pressure in the main conduit 71 of the static pressure circuit side detected by the pressure gauge 65 by the fluid pressure equivalent to the re-generating braking force. That is, the controller 9 controls the linear valve 27 so that the linear valve 27 generates the differential pressure corresponding to the fluid pressure equivalent to the re-generating or regenerative braking force. As a result, this braking control device can reduce the fluid pressure braking force applied to the rear wheels 5 by the braking force corresponding to the re-generating braking force. Therefore, the brake feeling is not as susceptible to deteriorating under the cooperative control.

Under the cooperative control, when the re-generating braking force increases based on changes in the vehicle speed, the amount of the electric energy stored in the battery 1 and other factors, the fluid pressure braking force applied to the rear wheels 5 needs to be reduced by the braking force equivalent to the increase amount of the re-generating braking force. In this case, the controller 9 controls the fluid pressure adjusting means to the pressure decrease mode, and reduces the fluid pressure applied to the wheel cylinders 25 by the fluid pressure equivalent to the increase amount of the re-generating braking force so as not to change the total amount of the braking force applied to the vehicle.

On the other hand, under the cooperative control, when the re-generating braking force decreases based on a changes in the vehicle speed, the amount of the electric energy stored in the battery 1 and other factors, the controller 9 controls the linear valve 27 to reduce the differential pressure generated by the linear valve 27 by the fluid pressure equivalent to the amount of decrease of the re-generating braking force. Therefore, the fluid pressure applied to the wheel cylinder 25 increases by the fluid pressure equivalent to the decrease amount of the re-generating braking force so as not to change the total amount of the braking force applied to the vehicle.

As mentioned above, according to the present invention, the cooperative control is not as susceptible to a deterioration in the brake feeling of the driver and can be executed merely by adding the electric energy re-generating means and at least one linear valve 27 to the known fluid pressure braking system.

Also, the linear valve 27 is disposed only in the dynamic pressure circuit side and is not disposed in the static pressure circuit side. Therefore, even when the controller 9 and the linear valve 27 and other elements fail, the fluid pressure generated by the master cylinder 13 according to the depressing force of the brake pedal is ensured as the braking force to be achieved, thus providing a fail-safe mechanism.

Moreover, because the static pressure circuit side is independent of the dynamic pressure circuit side, the controlling influence associated with the linear valve 27 disposed in the dynamic pressure circuit side is not transmitted to the static pressure circuit side which generates the fluid pressure according to the depressing force of the brake pedal. Therefore, the brake feeling is not significantly deteriorated during switching between the cooperative control mode and uncooperative control mode.

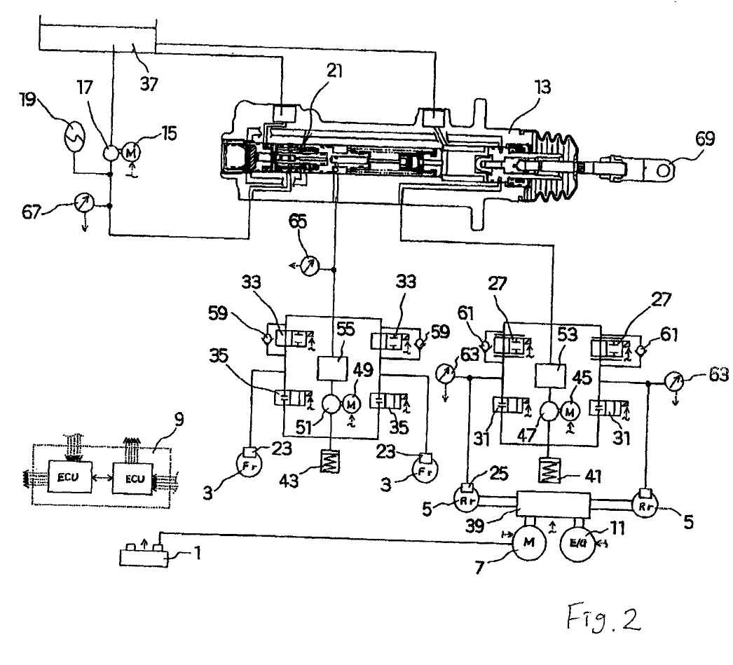

FIG. 2 illustrates a braking control device for an electrically-powered vehicle according to a second embodiment of the present invention. The elements in FIG. 2 that correspond to those in FIG. 1 are designated by the same reference numerals and a detailed description of such features is not repeated here.

The difference between the embodiment of the present invention shown in FIG. 1 and the embodiment illustrated in FIG. 2 is that the linear valve 27 is also used as the normally-opened electromagnetic valves 29 of the fluid pressure adjusting means. Therefore, two linear valves 27 are disposed at the positions of the normally-opened electromagnetic valves 29 of the fluid pressure adjusting means in FIG. 1. The structure and operation of the other elements are the same as those described above in connection with the embodiment shown in FIG. 1.

In the braking control devices for electrically-powered vehicles according to the embodiments of the present invention as described above, the static pressure circuit side corresponds to the front wheel side and the dynamic pressure circuit side corresponds to the rear wheel side. However, it is to be understood that a braking control device which has the opposite combination can work in the same way. The drive wheel side can correspond to the static pressure circuit side, while the drive wheel side corresponds to the dynamic pressure circuit side in those embodiments as mentioned above. Moreover, the present invention has application to four wheel drive vehicles.

The principles, preferred embodiments and modes of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A braking control device for an electrically-powered vehicle comprising:
a battery that stores electric energy;
an electric motor that drives at least one of a first wheel and a second wheel with the electric energy of the battery;
electric energy re-generating means for restoring the electric energy generated by the electric motor to the battery according to revolution of the at least one of the first and second wheels driven by the electric motor;
static pressure generating means for generating fluid pressure according to a depressing force of a brake pedal;
dynamic pressure generating means for generating fluid pressure substantially equal to the fluid pressure generated by the static pressure generating means;
first fluid pressure braking means connected to the static pressure generating means and applying a braking force to the first wheel according to the fluid pressure applied to the first fluid pressure braking means;
second fluid pressure braking means connected to the dynamic pressure generating means and applying a braking force to the second wheel according to the fluid pressure applied to the second fluid pressure braking means;
valve means disposed in a fluid conduit connecting the dynamic pressure generating means to the second fluid pressure braking means for generating designated differential pressure successively; and
control means for controlling the valve means on the basis of sensor signals so that the valve means generates a differential pressure corresponding to the fluid pressure equivalent to the re-generating braking force applied by the electric energy re-generating means.

2. The braking control device for an electrically-powered vehicle according to claim 1, wherein the valve means includes a linear valve.

3. The braking control device for an electrically-powered vehicle according to claim 1, wherein the sensors include a pressure gauge detecting the fluid pressure generated by the static pressure generating means and a pressure gauge detecting the fluid pressure at the downstream side of the valve means.

4. The braking control device for an electrically-powered vehicle according to claim 1, including fluid pressure adjusting means for adjusting the fluid pressure applied to the second fluid pressure braking means, the fluid pressure adjusting means being controlled by the control means and disposed in a fluid conduit connecting the valve means to the second fluid pressure braking means, the fluid pressure adjusting means including plural electromagnetic valves.

5. The braking control device for an electrically-powered vehicle according to claim 1, including fluid pressure adjusting means controlled by the control means and disposed in a fluid conduit connecting the dynamic pressure generating means to the second fluid pressure braking means, the fluid pressure adjusting means including plural electromagnetic valves, one of the plural electromagnetic valves being the valve means which adjusts the fluid pressure applied to the second fluid pressure braking means.

6. An electric vehicle braking control device comprising:
a battery that stores electric energy;
an electric motor that drives at least one of a first wheel and a second wheel with the electric energy of the battery, with electric energy generated by the electric motor being restored to the battery based on rotation of the at least one of the first and second wheels driven by the electric motor;
a master cylinder that generates fluid pressure according to a depressing force of a brake pedal;
a pump connected to a reservoir to draw fluid from the reservoir and supply fluid pressure;
a regulator connected to the pump to receive the fluid pressure from the pump and regulate the fluid pressure to be substantially equal to the fluid pressure generated by the master cylinder;
a first wheel cylinder connected to the master cylinder to apply a braking force to the first wheel;
a second wheel cylinder connected to the regulator to apply a braking force to the second wheel;
a linear valve disposed in a fluid conduit connecting the regulator to the second wheel cylinder for generating a designated differential pressure; and
a controller connected to the linear valve to control the linear valve to generate the differential pressure corresponding to a fluid pressure equivalent to a re-generating braking force applied by the motor.

7. The electric vehicle braking control device according to claim 6, including a pair of linear valves and a pair of second wheel cylinders, one of the linear valves being disposed in the fluid conduit connecting the regulator to one of the second wheel cylinders and the other linear valve being disposed in a fluid conduit connecting the regulator to the other second wheel cylinder.

8. The electric vehicle braking control device according to claim 6, including a first pressure gauge connected to the controller and detecting the fluid pressure generated by the master cylinder and a second pressure gauge connected to the controller and detecting the fluid pressure downstream of the linear valve, said controller controlling the linear valve based on output signals from the first and second pressure gauges.

9. The electric vehicle braking control device according to claim 6, including a pressure gauge connected to the controller and detecting the fluid pressure generated by the master cylinder, said controller controlling the linear valve based on an output signal from the pressure gauge.

10. The electric vehicle braking control device according to claim 6, including a pressure gauge connected to the controller and detecting the fluid pressure downstream of the linear valve, said controller controlling the linear valve based on an output signal from the pressure gauge.

11. The electric vehicle braking control device according to claim 6, including a normally open valve and a normally closed valve connected to the controller and positioned to adjust the fluid pressure applied to the second wheel cylinder.

12. The electric vehicle braking control device according to claim 11, wherein the normally open valve and the normally closed valve are disposed in a fluid conduit connecting the linear valve to the second wheel cylinder

13. The electric vehicle braking control device according to claim 6, including a plurality of electromagnetic valves connected to the controller and positioned to adjust the fluid pressure applied to the second wheel cylinder.

14. The electric vehicle braking control device according to claim 13, wherein the electromagnetic valves are disposed in a fluid conduit connecting the linear valve to the second wheel cylinder

15. The electric vehicle braking control device according to claim 6, including a plurality of electromagnetic valves connected to the controller and disposed in a fluid conduit connecting the regulator to the second wheel cylinder to adjust the fluid pressure applied to the second wheel cylinder, the linear valve comprising one of the electromagnetic valves.
